(19) United States
(12) Patent Application Publication
(10) Pub. No.: US 2005/0079894 A1
(43) Pub. Date: Apr. 14, 2005

(54) Electronic directory of phone numbers, mobile terminal having the same and management method thereof

(75) Inventors: Sang-Ho Shin, Seoul (KR); Ho-Hee Lee, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 10/828,324

(22) Filed: Apr. 21, 2004

(30) Foreign Application Priority Data
Oct. 8, 2003 (KR) 2003-0069948

(51) Int. Cl. H04M 11/00

(52) U.S. Cl. 455/564; 455/566; 455/550.1

(57) ABSTRACT

An electronic directory of phone numbers, a mobile terminal having the same, and a management method thereof. The electronic directory of phone numbers includes a plurality of graphic icons; and a plurality of phone numbers respectively linked to the plurality of graphic icons. The plurality of graphic icons form a graphic map. The graphic map includes a community configured by the icons. Each of the icons is updated according to a call history based on a phone number mapped thereto.

### BACKGROUND OF THE INVENTION

1. Field of the Invention

The present invention relates to an electronic directory of phone numbers, and more particularly to an electronic directory of phone numbers, a mobile terminal having the same, and a management method thereof.

2. Description of the Related Art

Typically, a mobile (communication) terminal such as a cellular or personal communication service (PCS) phone provides a user with an electronic telephone directory for storing and managing a plurality of phone numbers, etc. The electronic telephone directory provided in the mobile terminal stores names and phone numbers of opposite parties inputted by the user, and each of the stored data units has a memory address. A stored phone number can be retrieved from a memory. For example, the memory stores opposite names, opposite phone numbers and memory address data units, etc. Addition, deletion or correction operation can be performed in the electronic telephone directory.

In the conventional electronic directory of phone numbers, a desired phone number can be retrieved from the electronic directory using a name, a phone number or a memory address. The conventional electronic directory is based on text. However, as user demand on graphic-based content increases recently, a need exists for an electronic telephone directory providing the graphic-based content that can satisfy the user demand.

### SUMMARY OF THE INVENTION

It is an object of the present invention to provide an electronic directory of phone numbers and a mobile terminal having the same that provide graphic-based phone number information.

It is another object of the present invention to provide an electronic directory of phone numbers and a mobile terminal having the same that can allow a user to conveniently retrieve a desired phone number from a plurality of phone numbers through graphic-based phone number information.

It is yet another object of the present invention to provide a method of managing an electronic directory of phone numbers having graphic-based phone number information.

In accordance with a first aspect of the present invention, the above and other objects can be accomplished by the provision of an electronic directory of phone numbers, comprising: a plurality of graphic icons; and a plurality of phone numbers respectively linked to the plurality of graphic icons.

In accordance with a second aspect of the present invention, the above and other objects can be accomplished by the provision of a mobile terminal, comprising: an electronic directory of phone numbers comprising a plurality of graphic icons, and a plurality of phone numbers respectively linked to the plurality of graphic icons; and controlling means for controlling and managing the electronic directory.

In accordance with a third aspect of the present invention, the above and other objects can be accomplished by the provision of a method for managing an electronic directory of phone numbers in a mobile terminal, comprising: downloading a graphic icon from a service provider; and linking the graphic icon with a phone number.

In accordance with a fourth aspect of the present invention, the above and other objects can be accomplished by the provision of an electronic directory of phone numbers, comprising: a plurality of symbols; and a plurality of phone numbers respectively linked to the plurality of symbols.

In accordance with a fifth aspect of the present invention, the above and other objects can be accomplished by the provision of a mobile terminal, comprising: an electronic directory of phone numbers comprising a plurality of symbols, and a plurality of phone numbers respectively linked to the plurality of symbols; and controlling means for controlling and managing the electronic directory.

In accordance with a sixth aspect of the present invention, the above and other objects can be accomplished by the provision of a method for managing an electronic directory of phone numbers in a mobile terminal, comprising: downloading a symbol from a service provider; and linking the symbol with a phone number.

Therefore, the mobile terminal configures an electronic directory of telephone numbers based on the graphic map, resulting in greater convenience for a user who desires either to search for a specific phone number or to register a new phone number, as well as the user's visual pleasure.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A to 1C are exemplary screens linked to an electronic directory of phone numbers in accordance with a preferred embodiment of the present invention;

FIG. 2 is a block diagram illustrating a mobile terminal equipped with the electronic directory of phone numbers in accordance with a preferred embodiment of the present invention;

FIG. 3 is a block diagram illustrating components of a controller and components of a memory provided in the mobile terminal shown in FIG. 2 in accordance with a preferred embodiment of the present invention;

FIG. 4 is a flow chart illustrating a process for registering new phone number data in accordance with a preferred embodiment of the present invention;

FIG. 5 is a flow chart illustrating a process for searching for phone number data in accordance with a preferred embodiment of the present invention;

FIG. 6 is a flow chart illustrating a process for changing an icon in accordance with a preferred embodiment of the present invention; and

FIG. 7 is a flow chart illustrating a process for updating an icon in accordance with a preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

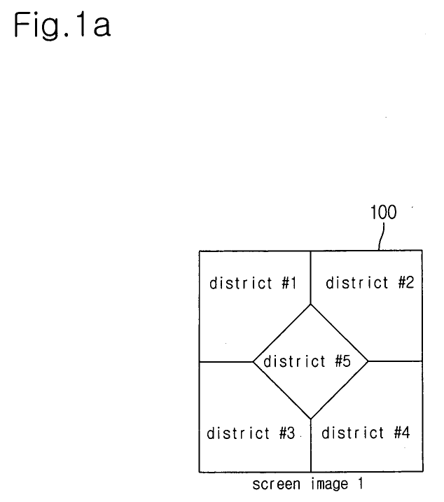

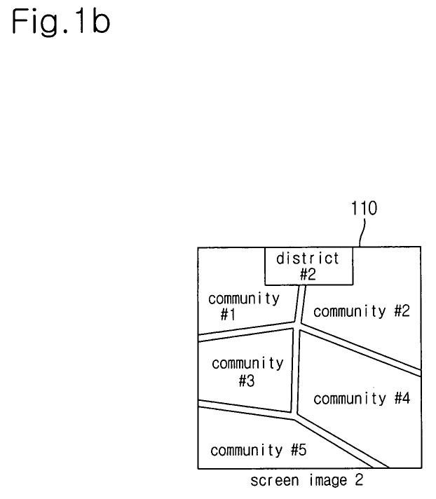

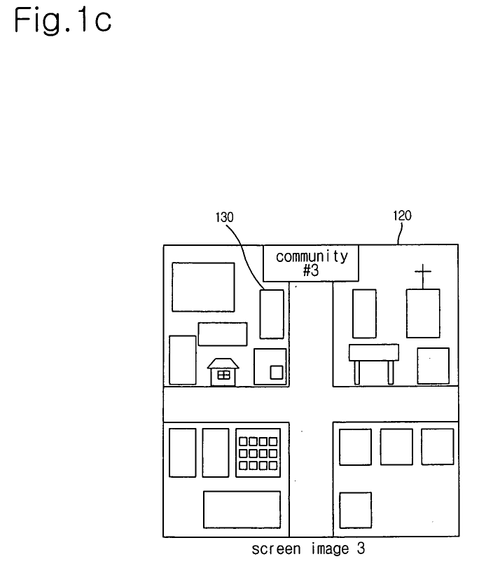

FIGS. 1A to 1C are exemplary screens linked to an electronic directory of phone numbers in accordance with a preferred embodiment of the present invention. In detail, FIG. 1A shows a 1^{st} screen linked to the electronic directory of phone numbers in accordance with the present invention. The 1^{st} screen displays a 1^{st} graphic map 100 indicating a plurality of districts. FIG. 1B shows a 2^{nd} screen linked to the 1^{st} screen. The 2^{nd} screen displays a 2^{nd} graphic map 110 indicating a plurality of communities belonging to a corresponding district shown in FIG. 1A. FIG. 1C shows a 3^{rd} screen linked to the 2^{nd} screen. The 3^{rd} screen displays a 3^{rd} graphic map 120 indicating a plurality of symbols or icons 130 of buildings, houses, stores, etc., belonging to a community shown in FIG. 1B. Here, the names of districts, communities and icons corresponding to buildings, houses, stores, etc. can be given and changed by a user. Each of the icons 130 is linked to at least one phone number.

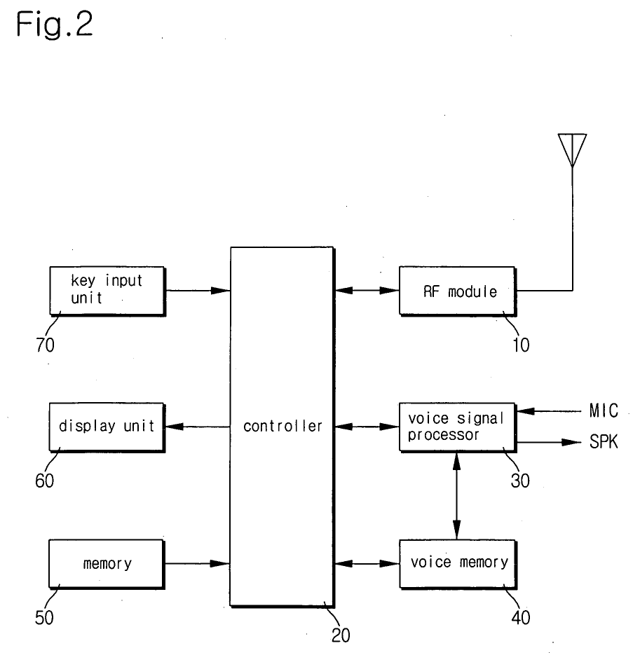

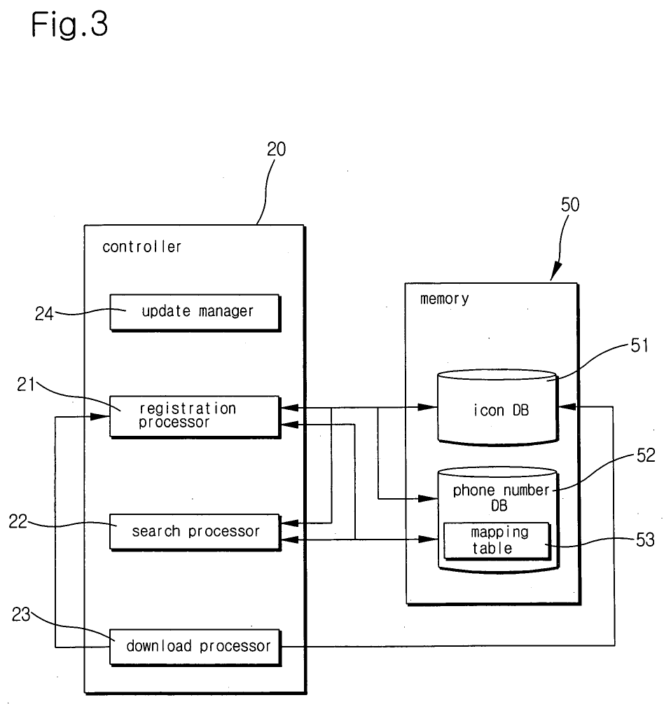

When a desired icon 130 is selected or clicked, a phone number linked to the selected or clicked icon 130 is retrieved from a phone number database (DB) (indicated by reference numeral 52 shown in FIG. 3), and the retrieved phone number is displayed on a display unit (indicated by reference numeral 60 shown in FIG. 2).

For example, in order to register a phone number of a friend whose name is Tom, a student worker working for a convenience store, the 1^{st} graphic map 100 having the plurality of districts is first displayed on a liquid crystal display (LCD) screen provided in a mobile terminal. Thus, the user can select one district in which a new phone number is to be registered, from the 1^{st} graphic map 100. When the user selects a corresponding district from the 1^{st} graphic map 100 of FIG. 1A, the 2^{nd} graphic map 110 of FIG. 1B is displayed so that the user can select one of the communities belonging to the selected district.

Then, when the user selects a corresponding community from the 2^{nd} graphic map 110 shown in FIG. 1B, the 3^{rd} graphic map 120 constituted by the icons 130 linked to the selected community is displayed as shown in FIG. 1C. The user selects one of the icons 130 and gives a name “convenience store” to the selected icon 130 and then inputs a phone number of the user's friend, such that the phone number of the user's friend is registered in the phone number DB to be linked to the icon “convenience store”.

In order to retrieve the phone number of his or her friend working for the “convenience store” registered in the electronic directory, the user selects a corresponding district from the 1^{st} graphic map 100 shown in FIG. 1A and then selects a corresponding community from the 2^{nd} graphic map 110 shown in FIG. 1B, such that the 3^{rd} graphic map 120 indicative of the selected community is displayed as shown in FIG. 1C. Then, the user clicks a corresponding icon 130 indicative of the convenience store from the 3^{rd} graphic map 120 shown in FIG. 1C. Consequently, a phone number and name of his or her friend, another personal information unit or etc. linked to the icon “convenience store” are retrieved from the phone number DB and then are displayed on the LCD screen (not shown) according to a result of the retrieval.

The icons 130 can be downloaded from a content provider (not shown) in the same way as a conventional method for downloading contents such as ring tones, background images, avatars, etc.

The mobile terminal may further include an additional function for automatically varying a color or shape of a corresponding icon 130 linked to a predetermined phone number according to a call history of phone number use. For example, the more the predetermined phone number is called, the brighter a color of the icon 130 linked to the phone number is or the larger the icon is. Therefore, the user can take interest in managing the electronic directory of phone numbers or the electronic phone book as if he or she were playing a game.

The electronic directory of phone numbers can be constituted in a hierarchical structure as shown in FIGS. 1A to 1C. However, it should be noted that the electronic directory is not limited to the above-described embodiment of the present invention and various modifications and additions are possible.

For example, assuming that 500 phone numbers can be stored in the phone number DB, the number of districts is five and each of the five districts can store 100 phone numbers. The electronic directory of phone numbers in accordance with the present invention described above can be employed in various electronic products such as electronic organizers, personal computers (PCs), personal digital assistants (PDAs), and mobile terminals (e.g., cellular phones and personal communication service (PCS) phones), etc.

Now, a detailed description will be given of an example of applying the electronic directory of phone numbers to the mobile terminal in accordance with the present invention.

FIG. 2 is a block diagram illustrating the mobile terminal with the electronic directory of phone numbers in accordance with a preferred embodiment of the present invention.

Referring to FIG. 2, an RF (Radio Frequency) module 10 carries out a radio signal processing operation to communicate with a base station. For example, the RF module 10 up-converts a baseband signal into an RF signal, amplifies the RF signal and transmits the amplified RF signal through an antenna ANT. At this point, a conversion operation to an intermediate frequency (IF) signal can be carried out. Further, the RF module 10 down-converts an amplified RF signal received from the antenna ANT into a baseband signal. At this point, a conversion operation to an IF signal can be carried out.

A controller 20 demodulates the baseband signal from the RF module 10 or modulates the baseband signal to send the modulated baseband signal to the RF module 10. The controller 20 performs the modulation/demodulation operation according to a preset mobile communication technique. For example, the controller 20 can carry out a modulation/demodulation operation based on code division multiple access (CDMA) such as channel coding/decoding or orthogonal coding/decoding. The controller 20 controls an overall operation of the mobile terminal through control and management programs stored in a memory 50. For example, the controller 20 reads the program for managing the electronic directory of phone numbers from the memory 50 and executes the read program when an event of registering or retrieving a phone number is generated.

A voice signal processor 30 encodes a voice signal inputted through a microphone MIC according to an operating mode and transmits the encoded voice signal to the controller 20. Alternatively, the voice signal processor 30 stores the voice signal in a voice memory 40 to be described below under control of the controller 20. Moreover, the voice signal processor 30 decodes an encoded voice signal through the controller 20 and then outputs the decoded voice signal through a speaker SPK. Typically, the voice signal processor 30 includes analog circuits such as an amplifier and a filter, etc., an AD (Analog-to-Digital) converter, a DA (Digital-to-Analog) converter and a firmware module including a voice compression/decompression module.

The controller 20 controls access to the voice memory 40, and the voice memory 40 stores a plurality of voice messages.

The memory 50 is divided into a read only memory (ROM) for storing the control program to control the operations of the mobile terminal, and a random access memory (RAM) for temporarily storing generated data while the mobile terminal is controlled. Similarly, the controller 20 controls access to the memory 50.

A display unit 60 serving as a user interface visually displays text data, image data, avatars, background images, etc., under the control of the controller 20.

A key input unit 70 serving as a user interface includes a plurality of digit keys and a plurality of function keys. The key input unit 70 generates key data whenever the user presses an individual key, and outputs the generated key data to the controller 20.

FIG. 3 is a block diagram illustrating components of the controller 20 and components of the memory 50 provided in the mobile terminal.

As shown in FIG. 3, the memory 50 includes an icon database (DB) 51 and a phone number DB 52 equipped with a mapping table 53.

The icon DB 51 stores a plurality of 1^{st} graphic maps 100, a plurality of 2^{nd} graphic maps 110 displaying a plurality of communities and a plurality of 3^{rd} graphic maps 120 displaying a plurality of icons 130. Each of the icons 130 is mapped to a phone number in, for example, one-to-one correspondence. The icons 130 stored in the icon DB 51 are graphic icons indicative of avatars and buildings, etc.

The phone number DB 52 stores phone numbers inputted through the key input unit 70. Each of the phone numbers stored in the phone number DB 52 has a unique memory address. The phone number DB 52 includes the mapping table 53 in which memory addresses linked to the phone numbers, icons 130 linked to the memory addresses, and at least one 3^{rd} graphic map 120, in which the icons 130 are registered, are mapped to one another.

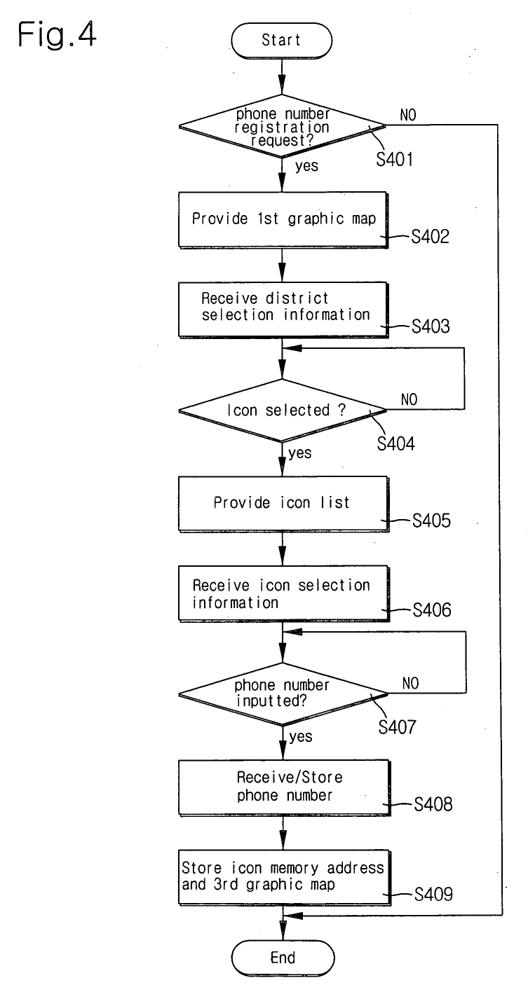

The controller 20 includes a registration processor 21 and a search processor 22. The registration processor 21 links a newly registered phone number to a corresponding icon 130, and stores the newly registered phone number and the icon 130 in the mapping table 53. Now, a method for registering a new phone number in the registration processor 21 will be described in detail with reference to FIG. 4.

FIG. 4 is a flow chart illustrating a process for registering new phone number data in accordance with a preferred embodiment of the present invention.

As shown in FIG. 4, if the user inputs a new phone number registration request at step S401, the controller 20 provides the user with the 1^{st} graphic map 100 having a plurality of districts through the display unit 60 at step S402. The controller 20 receives information of a district selected by the user at step S403. Where the electronic directory of telephone numbers is constituted in a hierarchical structure, the controller 20 can sequentially provide the 1^{st} graphic map 100 and the 2^{nd} graphic map 110 in response to the user's selection.

When the user selects a desired community from the 2^{nd} graphic map 110 at step S404, the registration processor 21 reads a list of icons 130 constituting the 3^{rd} graphic map 120 corresponding to the selected community and then provides the read icon list at step S405. Then, the registration processor 21 receives information of a specific icon 130 selected by the user at step S406.

When receiving the selected icon information, the registration processor 21 requests that the user input a new phone number to be mapped to the icon 130 selected by the user at step S407. The registration processor 21 receives the inputted phone number and stores the received phone number in the phone number DB 52 at step S408.

Further, the registration processor 21 stores the icon 130 selected by the user, a memory address of the inputted phone number and the 3^{rd} graphic map 120 containing the icon 130 in the mapping table 53 of the phone number DB 52 at step S409. Consequently, the icon linked to the newly registered phone number is newly registered in the 3^{rd} graphic map 120.

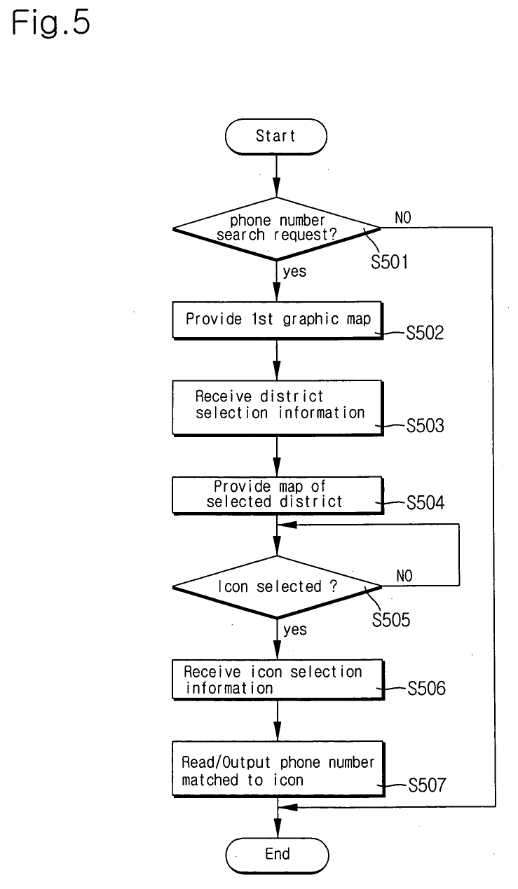

In response to a search request, the search processor 22 reads a phone number linked to an icon 130 selected by the user and outputs the phone number through the display unit 60. Now, a method for searching for a phone number in the search processor 22 will be described in detail with reference to FIG. 5.

FIG. 5 is a flow chart illustrating the method for searching for a phone number in accordance with a preferred embodiment of the present invention.

As shown in FIG. 5, if a phone number search request has been inputted at step S501, the search processor 22 provides the user with the 1^{st} graphic map 100 containing a plurality of districts through the display unit 60 at step S502. When the electronic directory of phone numbers is constituted in a hierarchical structure, the search processor 22 sequentially provides the 1^{st} graphic map 100 and the 2^{nd} graphic map 110 containing a plurality of communities belonging to a corresponding district in response to the user's selection.

When a specific community is selected from the 2^{nd} graphic map 110, the search processor 22 receives information of the selected specific community at step S503, and then provides the 3^{rd} graphic map 120 in which a plurality of icons 130 constitute the selected specific community at step S504. Then, when the user has selected a desired icon 130 from the 3^{rd} graphic map 120, the search processor 22 searches for a memory address mapped to the selected icon 130 from the mapping table 53 at step S505, reads a phone number mapped to the searched memory address from the phone number DB 52 at step S506, and outputs the read phone number through the display unit 60 at step S507.

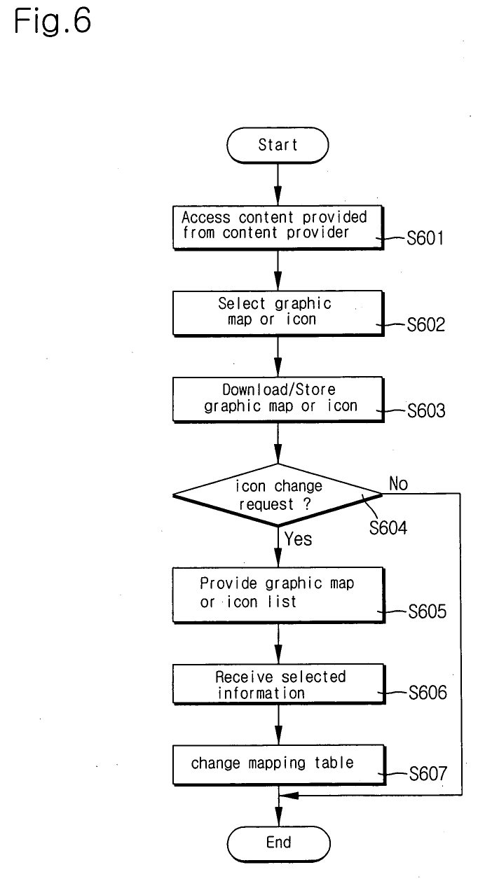

In accordance with the present invention, the controller 20 can further include a download processor 23. The download processor 23 downloads the icons 130, the 2^{nd} graphic map 110 or the 1^{st} graphic map 100 from a content provider (not shown), and stores the downloaded icons 130, the downloaded 2^{nd} graphic map 110 or the downloaded 1^{st} graphic map 100 in the icon DB 51. Now, the operation of the download processor 23 will be described in detail with reference to FIG. 6.

FIG. 6 is a flow chart illustrating a process for changing an icon in the download processor 23 in accordance with a preferred embodiment of the present invention.

As shown in FIG. 6, the user accesses content of a content provider (not shown) using the mobile terminal at step S601, and selects a desired map from a list of graphic maps 110 respectively containing a plurality of communities or a desired icon from a list of icons 130 at step S602. The download processor 23 downloads the selected graphic map 110 or icon 130 and stores the downloaded graphic map 110 or icon 130 in an internal memory of the mobile terminal at step S603.

If an icon change request is inputted from the user at step S604 after the selected icon 130 has been downloaded from the content provider and stored in the mobile terminal, the download processor 23 provides the user with the list of icons 130 to be changed at step S605.

If the user has selected an icon 130 to be changed from among the list of icons 130 at step S606, the download processor 23 outputs a changed icon registration request signal for the selected icon 130 to the registration processor 21. Then, the registration processor 21 changes the selected icon 130 to a newly downloaded icon 130 while keeping other registered contents of the mapping table 53 at step S607. In other words, the registration processor 21 changes only the selected icon 130 without changing phone number data linked to the selected icon 130, etc.

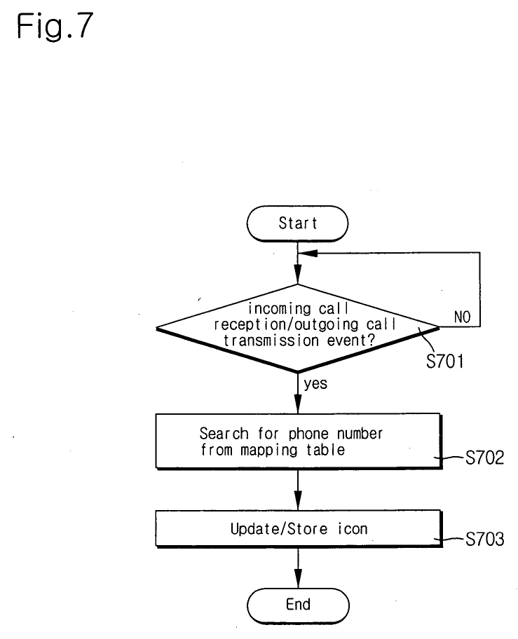

In accordance with the present invention, the controller 20 can further include an update manager 24. If an event such as an incoming call reception/outgoing call transmission is generated, the update manager 24 updates the shape of a corresponding icon 130 mapped to a specific phone number based on the generated event to a predetermined shape. For example, if an icon 130 mapped to a phone number of a friend is a building-shaped icon, the greater the number of phone calls between the user and the friend, the brighter a color of the icon 130 linked to the phone number is or the higher the icon 130 linked to the phone number is. Now, the operation of the update manager 24 will be described in detail with reference to FIG. 7.

FIG. 7 is a flow chart illustrating a process for managing the icon in accordance with a preferred embodiment of the present invention.

Referring to FIG. 7, the update manager 24 determines whether an incoming call reception or outgoing call transmission event has occurred at step S701. The update manager 24 searches for a corresponding phone number associated with the event from the matching table 53 at step S702, and updates the shape of an icon 130 corresponding to the phone number according to the number of event occurrences at step S703.

As apparent from the above description, the present invention provides a mobile terminal with an electronic directory of phone numbers based on a graphic map, resulting in greater convenience for a user who desires either to search for a specific phone number or to register a new phone number, as well as the user's visual pleasure.

In addition, icons and maps constituting the electronic directory of phone numbers can be downloaded from a content provider, such that the electronic directory can be freely updated or changed according to the user's desires.

Furthermore, if a phone call event occurs, the mobile terminal updates an icon linked to a phone number according to the number of event occurrences, resulting in the user's visual pleasure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An electronic directory of phone numbers, comprising:
a plurality of graphic icons; and
a plurality of phone numbers respectively linked to the plurality of graphic icons.

2. The electronic directory of claim 1, wherein the plurality of graphic icons form a graphic map.

3. The electronic directory of claim 2, wherein the graphic map comprises a community configured by the icons.

4. The electronic directory of claim 1, wherein each of the icons is updated according to a call history based on a phone number mapped thereto.

5. A mobile terminal, comprising:
an electronic directory of phone numbers comprising a plurality of graphic icons, and a plurality of phone numbers respectively linked to the plurality of graphic icons; and
controlling means for controlling and managing the electronic directory.

6. The mobile terminal of claim 5, wherein the controlling means includes:
a registration processor for registering a desired phone number; and
a search processor for searching for a desired phone number.

7. The mobile terminal of claim 5, wherein the control means includes:
an update manager for varying a shape or a color of the graphic icon.

8. The mobile terminal of claim 5, wherein the control means includes:
a download processor for downloading the graphic icon from a service provider.

9. The mobile terminal of claim 5, wherein the plurality of icons form a graphic map.

10. The mobile terminal of claim 9, wherein the graphic map comprises a community configured by the icons.

11. The mobile terminal of claim 7, wherein each of the icons is updated according to a call history based on a phone number mapped thereto.

12. The mobile terminal of claim 5, further comprising, a memory having a plurality of icons.

13. A method for managing an electronic directory of phone numbers in a mobile terminal, comprising:
downloading a graphic icon from a service provider; and
linking the graphic icon with a phone number.

14. The method of claim 13, further comprising:
updating the graphic icon according to a call history of the phone number.

15. An electronic directory of phone numbers, comprising:
a plurality of symbols; and
a plurality of phone numbers respectively linked to the plurality of symbols.

16. The electronic directory of claim 15, wherein the plurality of symbols form a map.

17. The electronic directory of claim 16, wherein the map comprises a community configured by the symbols.

18. The electronic directory of claim 15, wherein each of the symbols is updated according to a call history based on a phone number mapped thereto.
